(19) United States
(12) Patent Application Publication
(10) Pub. No.: US 2020/0272851 A1
(43) Pub. Date: Aug. 27, 2020

(54) CONFIGURATION MANAGEMENT DEVICE, CONFIGURATION MANAGEMENT METHOD, AND RECORDING MEDIUM

(71) Applicant: NEC Corporation, Minato-ku, Tokyo (JP)

(72) Inventor: Manabu NAKANOYA, Tokyo (JP)

(73) Assignee: NEC Corporation, Minato-ku, Tokyo (JP)

(21) Appl. No.: 16/754,454

(22) PCT Filed: Oct. 4, 2018
(86) PCT No.: PCT/JP2018/037182

§ 371 Date: Apr. 8, 2020

(30) Foreign Application Priority Data
Oct. 10, 2017 (JP) 2017-197022

(51) Int. Cl. G06K 9/62; G06N 7/00; G06N 5/02; G06F 8/71

(52) U.S. Cl. CPC G06K 9/6215; G06F 8/71; G06N 5/025; G06N 7/005

(57) ABSTRACT

A configuration management device 10 is a configuration management device that learns a change procedure by executing a trial change procedure among configuration change procedures for a system to be managed. The configuration management device includes: similarity computation means 11 that computes, in accordance with a type of parameter, a degree of similarity between a candidate parameter to be included in the trial change procedure and a parameter which is included in an already-executed change procedure; and probability computation means 12 that computes a probability that the candidate parameter is included in the trial change procedure by employing the computed degree of similarity.

### TECHNICAL FIELD

The present invention relates to a configuration management device, a configuration management method, and a recording medium, and particularly relates to a configuration management device, a configuration management method, and a recording medium that can learn a change operation procedure of a system whose configuration is managed and changed by reinforcement learning.

### BACKGROUND ART

Tasks that are repeatedly executed in configuration management and configuration change of an information technology (IT) system can be roughly divided into three. A first task is a task to grasp a configuration of a currently operating system. A second task is a task to define a change requirement. A third task is a task to generate a change operation procedure (hereinafter, referred to as a change procedure) derived from an execution result of the first task and an execution result of the second task, and a task to execute the generated change procedure.

Among the three tasks described above, the third task to generate a change procedure and execute the generated change procedure is a task that requires a lot of man-hours, especially when executed manually. Various automation technologies have been developed and proposed that can reduce man-hours required for the third task.

For example, Non Patent Literatures (NPLs) 1 and 2 describe software tools that automatically execute a change operation. The software tools described in NPLs 1 and 2 are tools that automatically change and set a system by inputting a state after the system is changed and definition information on a change operation procedure at the time of the change.

However, the software tools described in NPLs 1 and 2 automatically execute only a change operation, and do not automatically generate a change procedure. As a technique for automatically generating a change procedure, Patent Literature (PTL) 1 describes a change planning system that generates a procedure required for change by defining operation states of components of an IT system and a constraint between the operation states.

Further, in a method of expressing a relationship between a state of a part and a constraint by using a state transition diagram, generally, a method of converting between system design information and the state transition diagram becomes an issue. PTL 2 describes a change management system that can solve the above-described problem and efficiently describes a model having a state.

When the change planning system described in PTL 1 and the change management system described in PTL 2 are used, information indicating a configuration change procedure is generated in an input format of a software tool that automatically executes the change procedure described in NPLs 1 and 2. That is, everything from generation to execution of the change procedure is automatically performed.

As described above, a system administrator can automatically generate a change procedure by using the change planning system described in PTL 1 and the change management system described in PTL 2. However, when using the change planning system and the change management system, the system administrator is required to define in advance operation states of components of the IT system and a constraint between the operation states.

Definition information indicating the operation states of the components of the IT system and the constraint between the operation states is information that is difficult to generate by a method other than a method of manual generation by a technician who is familiar with the operation of the components of the IT system to be managed. That is, the generation of the definition information described above is a new factor that increases man-hours required for configuration change of the system.

In order to easily generate the definition information, for example, it is conceivable to execute processing to check dependency between the components of the system, and to detect information indicating the dependency between the components. Dependency is required to be checked for all combinations of components.

Further, among techniques for executing processing to derive an appropriate change procedure, a technique using reinforcement learning is widespread. For example, NPLs 3 and 4 describe techniques of performing a trial of change operations on various combinations of applications and server resources such as a central processing unit (CPU) and a memory allocation amount, and deriving an optimum change procedure and change parameters by evaluating and learning a trial result.

In reinforcement learning, a scalar value called a reward indicating “desirability” of a state or control is defined for a state of a control target or control in a predetermined state. A subject that learns, which is generally called an agent, performs learning by sequentially acquiring rewards from an external environment in which control of a learning target is executed. A relatively large value among the acquired rewards for various states and control is expressed as “high reward”.

In the field of reinforcement learning, research has been conducted on a speed-up technique for completing learning within a realistic time when the number of combinations of control of learning targets (for example, change operations) is enormous.

For example, NPL 5 describes a technique for realizing efficient learning for a reinforcement learning problem in which an operation is defined in a continuous space such as a real number, such as robot control. When an operation is defined in a continuous space, the number of combinations in the reinforcement learning problem tends to be enormous even if appropriate discretization is performed.

Specifically, the technique described in NPL 5 realizes efficiency of learning by sequentially defining control of a learning target by using a normal distribution or the like with control that has obtained a high reward as an average, on the basis of the assumption that a high reward is likely to be obtained similarly from control having a value close to the control that has obtained a high reward.

Further, PTL 3 describes an automated action-selection method for selecting which trials or actions should be tried next in order to achieve efficient learning. Further, PTL 4 describes a system change assistance system that can correctly process a change request that differs only in a value of an item that may be changed.

### CITATION LIST

### Patent Literature

PTL 1: Japanese Patent Application Laid-Open No. 2015-215885

PTL 2: Japanese Patent Application Laid-Open No. 2015-215887

PTL 3: Japanese Translation of PCT International Application Publication No. JP-T-2008-508581

PTL 4: International Publication No. 2017/033389

### Non Patent Literature

NPL 1: “Puppet 5.1 reference manual”, [online], Puppet, [Searched on Sep. 5, 2017], Internet <https://docs.puppet.com/puppet/5.1/index.html>

NPL 2: “Ansible (registered trademark) v 2.4”, [online], Ansible, [Searched on Sep. 5, 2017], Internet <http://docs.ansible.com/ansible/latest/intro.html>

NPL 3: J. Rao, X. Bu, C. Z. Xu and K. Wang, “A Distributed Self-Learning Approach for Elastic Provisioning of Virtualized Cloud Resources”, In 19th Annual IEEE International Symposium on Modelling, Analysis, and Simulation of Computer and Telecommunication Systems, IEEE, 2011, pages 45 to 54.

NPL 4: I. J. Jureta, S. Faulkner, Y. Achbany and M. Saerens, “Dynamic Web Service Composition within a Service-Oriented Architecture”, In IEEE International Conference on Web Services, IEEE, 2007, pages 1 to 8.

NPL 5: Cheng-Jian Lin and Chin-Teng Lin, “Reinforcement learning for an ART-based fuzzy adaptive learning control network”, IEEE TRANSACTIONS ON NEURAL NETWORKS, IEEE, 1996, 7 (3), pages 709 to 731.

### SUMMARY OF INVENTION

### Technical Problem

Research methods described in NPLs 3 and 4 that experimentally perform trials of many patterns have a problem that trials and learning are not completed within a realistic time if the number of patterns of a change procedure that is a trial candidate becomes enormous. That is, an applicable range of the research methods described in NPLs 3 and 4 is limited to a special case in which the number of patterns and parameters of the change procedure is small.

However, in general, in a change procedure of an IT system, the number of combinations of changed portions and parameter values specified at the time of change often becomes enormous. Therefore, it is difficult for a general reinforcement learning technique using the techniques described in NPLs 3 and 4 described above to learn the change procedure of the IT system.

The technique described in NPL 5 is applied only to a case where a parameter for determining control is defined in a continuous space such as a real number whose degree of similarity is obviously defined. Therefore, it is difficult to apply the technique described in NPL 5 to learning of a change procedure of an IT system including a parameter whose order and degree of similarity (distance) are not obviously defined.

Further, in the action-selection method described in PTL 3, and in the system change assistance system described in PTL 4, it is not supposed to learn a change procedure of an IT system that includes a parameter whose order and degree of similarity (distance) are not obviously defined.

### Object of Invention

Therefore, an object of the present invention is to provide a configuration management device, a configuration management method, and a recording medium that can reduce the trial number when learning a change procedure of an IT system, to solve the above-described problem.

### Solution to Problem

A configuration management device according to the present invention is a configuration management device that learns a change procedure by executing a trial change procedure among configuration change procedures for a system to be managed. The configuration management device includes: similarity computation means which computes, in accordance with a type of parameter, a degree of similarity between a candidate parameter to be included in the trial change procedure and a parameter which is included in an already-executed change procedure; and probability computation means which computes a probability that the candidate parameter is included in the trial change procedure by employing the computed degree of similarity.

The configuration management method according to the present invention is a configuration management method executed in a configuration management device that learns a change procedure by executing a trial change procedure among configuration change procedures for a system to be managed. The configuration management method includes: computing, in accordance with a type of parameter, a degree of similarity between a candidate parameter to be included in the trial change procedure and a parameter which is included in an already-executed change procedure; and computing a probability that the candidate parameter is included in the trial change procedure by employing the computed degree of similarity.

A computer readable recording medium that has recorded a configuration management program according to the present invention stores a configuration management program executed in a computer that learns a change procedure by executing a trial change procedure among configuration change procedures for a system to be managed. The configuration management program performs, when executed in the computer, computation, in accordance with a type of parameter, a degree of similarity between a candidate parameter to be included in the trial change procedure and a parameter which is included in an already-executed change procedure; and computation of a probability that the candidate parameter is included in the trial change procedure by employing the computed degree of similarity.

### Advantageous Effects of Invention

According to the present invention, it is possible to reduce the trial number when learning a change procedure of an IT system.

### BRIEF DESCRIPTION OF DRAWINGS

FIG. 1 is a block diagram showing a configuration example of a first exemplary embodiment of a configuration management device according to the present invention.

FIG. 2 is a block diagram showing a configuration example of a probability distribution determination unit 110 according to the first exemplary embodiment.

FIG. 3 is an explanatory diagram showing an example of a distance function generated on the basis of an inclusion relation.

FIG. 4 is an explanatory diagram showing an example of a distance function when an IPv4 address is specified as a parameter.

FIG. 5 is an explanatory diagram showing an example of a weighted score generation formula.

FIG. 6 is an explanatory diagram showing an example of a parameter selection probability generation formula and a probability distribution generated at an IPv4 address.

FIG. 7 is a flowchart showing an operation of a change procedure generation process by a configuration management device 100 of the first exemplary embodiment.

FIG. 8 is a block diagram showing another configuration example of the first exemplary embodiment of the configuration management device according to the present invention.

FIG. 9 is a block diagram showing an outline of a configuration management device according to another exemplary embodiment of the present invention.

FIG. 10 is an explanatory diagram showing an example of a hardware configuration that can execute a configuration management device according to each exemplary embodiment of the present invention.

### DESCRIPTION OF EMBODIMENTS

### First Exemplary Embodiment

### Description of Configuration

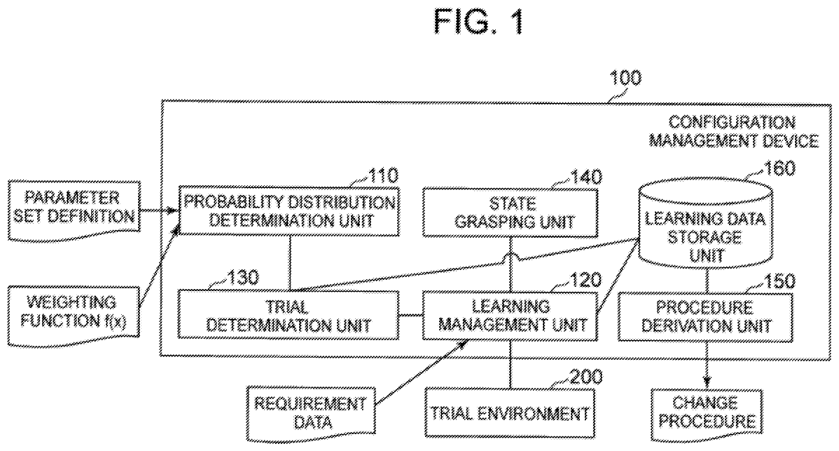

Hereinafter, an exemplary embodiment of the present invention will be described with reference to the drawings. FIG. 1 is a block diagram showing a configuration example of a first exemplary embodiment of a configuration management device according to the present invention.

The configuration management device of the present exemplary embodiment defines a degree of similarity (distance) between qualitative parameters that are difficult to quantify, and uses the defined degree of similarity to give priority to a pattern of a learning (trial) target.

The given priority corresponds to a score determined on the basis of the degree of similarity and learning progress information. Further, the degree of similarity (distance) between parameters is defined on the basis of an inclusion relation between parameters. Further, the definition of the inclusion relation is specified in advance for each type of parameter.

The configuration management device according to the present exemplary embodiment generates a probability distribution of a probability that a trial content is selected on the basis of the priority. Next, the configuration management device determines a trial content in accordance with the generated probability distribution, thereby more preferentially learning a correct change procedure including a valid operation for configuration change than many other invalid change procedures.

As shown in FIG. 1, the configuration management device 100 of the present exemplary embodiment includes a probability distribution determination unit 110, a learning management unit 120, a trial determination unit 130, a state grasping unit 140, a procedure derivation unit 150, and a learning data storage unit 160.

Further, as shown in FIG. 1, a parameter set definition and a weighting function are inputted to the probability distribution determination unit 110. Further, requirement data is inputted to the learning management unit 120. Further, the procedure derivation unit 150 outputs a change procedure.

The probability distribution determination unit 110 has a function of determining a selection probability of each trial content that is used for efficiently determining the trial content. The probability distribution determination unit 110 generates a probability distribution in which a selection probability of each trial content is specified.

The learning management unit 120 has a function of controlling each step for learning a change procedure that satisfies a requirement, by repeatedly executing trials on the basis of the inputted requirement data.

As shown in FIG. 1, the learning management unit 120 is communicably connected to a trial environment 200 in which a copy of an IT system to be managed is installed. The learning management unit 120 executes a trial content determined by the trial determination unit 130 in the trial environment 200.

Next, the learning management unit 120 extracts a trial result from the trial environment 200 in accordance with a content specified by the state grasping unit 140. The state grasping unit 140 has a function of checking a current requirement satisfaction status of the IT system operating in the trial environment 200 on the basis of the inputted requirement data. The learning management unit 120 evaluates the extracted trial result.

The trial determination unit 130 has a function of determining a next trial content on the basis of the inputted requirement data and the checked current requirement satisfaction status of the IT system.

The learning data storage unit 160 has a function of storing evaluation data of a trial result based on the trial content and the requirement satisfaction status of the IT system after the trial. That is, the learning data storage unit 160 stores past trial results. Note that, at the start of learning, no data is stored in the learning data storage unit 160.

The procedure derivation unit 150 has a function of deriving a change procedure that satisfies a requirement for the IT system, on the basis of stored learning data.

Hereinafter, an operation of learning a change procedure by the configuration management device 100 of the present exemplary embodiment will be described. A user inputs requirement data defining a change requirement of a target system, to the learning management unit 120. The requirement data includes a requirement of a system for which the user requests satisfaction, and control operations that may be required for satisfying the requirement.

The learning management unit 120 starts learning on the basis of the inputted requirement data. First, the learning management unit 120 inputs the requirement data to the state grasping unit 140.

The state grasping unit 140 specifies a checking process for checking whether or not the current trial environment 200 satisfies the requirement indicated by the inputted requirement data. Next, the state grasping unit 140 inputs the specified checking process to the learning management unit 120.

The learning management unit 120 executes the inputted checking process. Next, the learning management unit 120 stores a state of the trial environment 200 after the execution of the checking process. Next, the learning management unit 120 inputs, to the trial determination unit 130, a list of control operations that may be required to satisfy the requirement specified in the requirement data, in order to determine the control operation to be tried.

The trial determination unit 130 determines a next trial content by using a probability distribution, on the basis of the inputted list of control operations and a past trial result acquired from the learning data storage unit 160. The determination method by the trial determination unit 130 is an alternative method to a trial selection method such as an ε-greedy method in reinforcement learning.

In order to determine a next trial content by using a probability distribution, the trial determination unit 130 inputs a type of parameter to be determined and the past trial result, to the probability distribution determination unit 110.

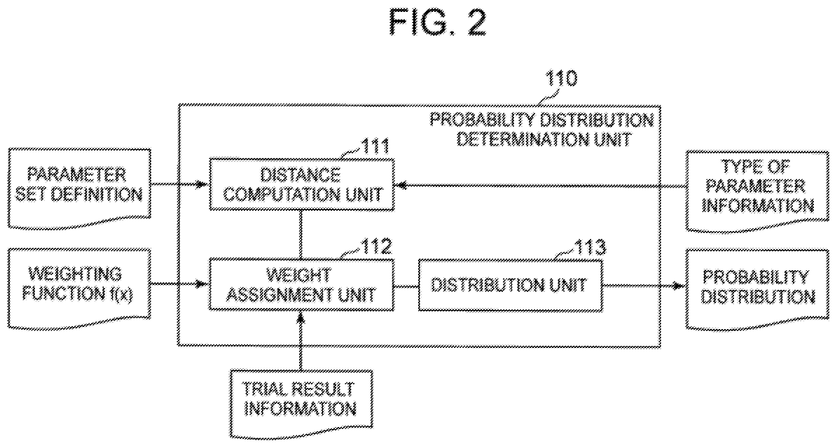

FIG. 2 is a block diagram showing a configuration example of the probability distribution determination unit 110 according to the first exemplary embodiment. As shown in FIG. 2, the probability distribution determination unit 110 includes a distance computation unit 111, a weight assignment unit 112, and a distribution unit 113.

Further, as shown in FIG. 2, a parameter set definition is inputted to the distance computation unit 111 in advance. Further, a weighting function is inputted to the weight assignment unit 112 in advance.

The distance computation unit 111 has a function of computing a degree of similarity (distance) between parameters according to a type of parameter.

The weight assignment unit 112 has a function of assigning a weight according to evaluation data of the past trial result and a distance between a parameter in the trial result and a parameter included in the trial content. By assigning a weight, the weight assignment unit 112 gives a score to the parameter included in the trial content.

The distribution unit 113 has a function of generating a probability distribution on the basis of the score computed by the weight assignment unit 112.

In the parameter set definition of the present exemplary embodiment, a parent-child relationship (inclusion relation) of elements according to a set type is defined. The set type is, for example, a directory of a Linux (registered trademark) file system or an Internet protocol (IP) address.

For example, “192.168.255.248”, which is an element of a set of IPv4 addresses, has a minimum subnet mask length of 29 when interpreted as a network address. IPv4 addresses belonging to the same subnet as a network address when the subnet mask length is 29 are eight addresses of “192.168.255.248”, “192.168.255.249”, “192.168.255.250”, “192.168.255.251”, “192.168.255.252”, “192.168.255.253”, “192.168.255.254”, and “192.168.255.255”, including the network address itself.

Due to the inclusion relation, “192.168.255.248” is the parent among the eight addresses, and the remaining seven addresses are the children. In the parameter set definition of the present exemplary embodiment, the method of computing the parent-child relationship for each type of parameter as described above is specifically and individually defined.

As shown in FIG. 2, among data inputted by the trial determination unit 130, type of parameter information is inputted to the distance computation unit 111. Further, among data inputted by the trial determination unit 130, past trial result information is inputted to the weight assignment unit 112.

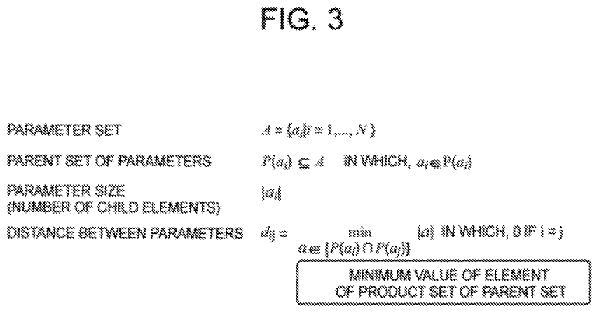

The distance computation unit 111 inputs a distance function corresponding to a type of parameter indicated by the inputted type of parameter information, to the weight assignment unit 112. The distance function is generated on the basis of the definition shown in FIG. 3, for example. FIG. 3 is an explanatory diagram showing an example of a distance function generated on the basis of the inclusion relation.

As shown in FIG. 3, when a parameter set A is expressed as A={aᵢ|i=1, . . . , N}, the parent set of parameters is P(aᵢ)⊆A. Note that, since aᵢ∈P(aᵢ), P(aᵢ) includes both the parent and child. Further, a size of the parameter (the number of child elements) is represented as |aᵢ|.

Using the above expression, in the example shown in FIG. 3, a distance between parameters is expressed as dᵢⱼ=min_{a∈{P(ai)∩P(aj)}}|a| (in which, 0 if i=j). That is, the distance dᵢⱼ means a minimum value of an element of a product set of the parent set.

The distance computation unit 111 quantifies a degree of similarity (distance) between two parameters as a minimum number of elements, among elements of a product set of the parent parameter set including each parameter. The distance function of the present exemplary embodiment is defined for each type of the parameter set, and is determined on the basis of the inclusion relation of the set elements described above. Note that the distance function of the present exemplary embodiment may be generated on the basis of a definition other than the definition shown in FIG. 3.

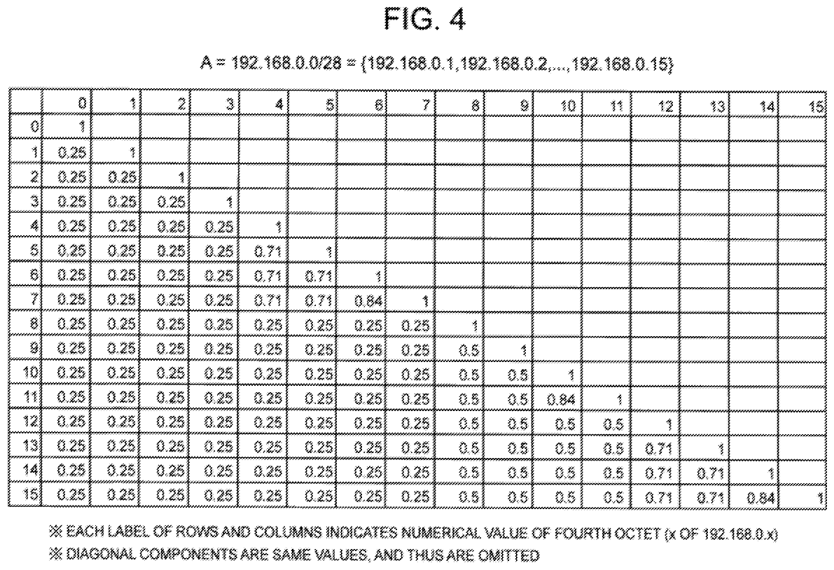

FIG. 4 is an explanatory diagram showing an example of a distance function when an IPv4 address is specified as a parameter. As shown in FIG. 4, a parameter set A is A=192.168.0.0/28. That is, the number of set elements is 15, since the network address is excluded.

Values in a matrix shown in FIG. 4 are values computed by the distance function. Note that a value of each label in a row and column shown in FIG. 4 is a numerical value of x in “192.168.0.x”. Further, the values in the matrix shown in FIG. 4 are the same in diagonal components. Note that, in the example shown in FIG. 4, a description of values on an upper right half of the matrix is omitted.

The weight assignment unit 112 inputted with the distance function uses the past trial result information and the weighting function, to generate a score that is weighted such that a higher score is given to a parameter that is closer to data indicated by past trial result information that has obtained a higher reward. The weight assignment unit 112 inputs the generated score to the distribution unit 113.

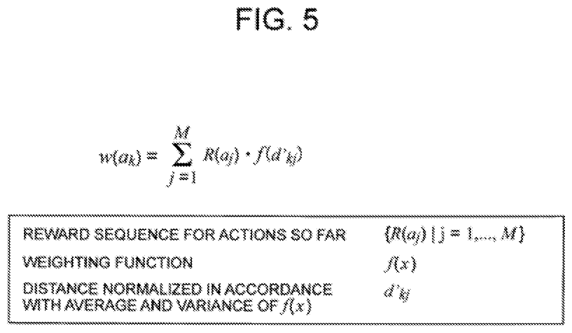

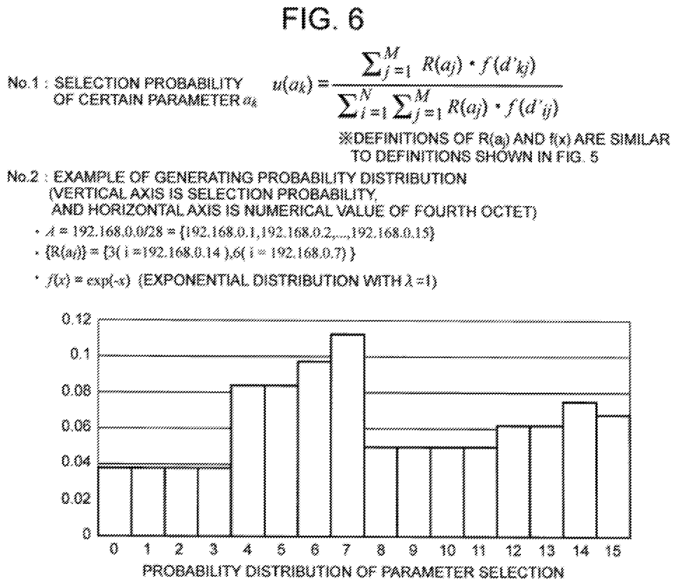

FIG. 5 is an explanatory diagram showing an example of a weighted score generation formula. In the example shown in FIG. 5, a weight w(aₖ) assigned to a parameter aₖ is computed as a sum of j=1 to M of a product of a reward sequence R(aⱼ) for a past action and a value at a normalized distance d′ₖⱼ of a weighting function f(x).

That is, the weight assignment unit 112 performs scoring on validity of a trial candidate parameter by using a degree (value) of contribution to the requirement satisfaction computed by the distance computation unit 111 and a distance between a parameter in the past trial result and a parameter of the trial candidate.

The distribution unit 113 inputted with the generated score generates a probability distribution on the basis of the score. The distribution unit 113 inputs the generated probability distribution to the trial determination unit 130. The distribution unit 113 generates a probability distribution after normalizing such that the sum of the scores is “1”, for example.

FIG. 6 is an explanatory diagram showing an example of a parameter selection probability generation formula and a probability distribution generated at an IPv4 address. The No. 1 of FIG. 6 shows an example of a definition formula of a selection probability u(aₖ) of a parameter aₖ. Note that respective definitions of R(aⱼ) and f(x) are similar to the definitions shown in FIG. 5.

The No. 2 of FIG. 6 shows a probability distribution generated on the basis of the example of the distance function shown in FIG. 4. A parameter set A is similar to the set A shown in FIG. 4. Further, a reward sequence R(aᵢ) is R(aᵢ)={3 (i=192.168.0.14), 6 (i=192.168.0.7)}. Further, a weighting function f(x) is f(x)=exp(−x), that is, an exponential distribution with λ=1.

The No. 2 of FIG. 6 shows a probability distribution of a parameter selection probability computed by the definition formula shown in the No. 1 of FIG. 6, generated under the above conditions. A numerical value on a vertical axis is the selection probability. A numerical value on a horizontal axis is a numerical value of x in “192.168.0.x”. As shown in the No. 2 of FIG. 6, a probability distribution is generated in which the probability that the parameter “192.168.0.7” is selected is highest.

The trial determination unit 130 inputted with the generated probability distribution adopts, as a next trial content (change procedure), a procedure including a parameter generated in accordance with the inputted probability distribution. Next, the trial determination unit 130 requests the learning management unit 120 for a trial of the adopted change procedure.

The learning management unit 120 inputted with a specific trial content (change procedure) from the trial determination unit 130 executes a change procedure in the trial environment 200. After executing the change procedure, the learning management unit 120 executes again the checking process specified by the state grasping unit 140 described above, to check the execution result.

After executing the checking process, the learning management unit 120 accumulates the change procedure of each trial content and the evaluation data of each trial result in the learning data storage unit 160.

As a result of repeated execution of the above processing, when the change operation that leads the IT system to a state satisfying the requirement is sufficiently learned, the procedure derivation unit 150 refers to the learning data storage unit 160 and extracts a change procedure that satisfies the requirement. Note that a condition for considering the learning to be completed is similar to a stop condition in learning such as general reinforcement learning.

The procedure derivation unit 150 outputs the extracted change procedure. Therefore, by executing the series of processes described above, the configuration management device 100 of the present exemplary embodiment can automatically generate a change procedure that satisfies the requirement on the basis of the inputted requirement data.

As described above, even in a case where the user inputs, into a reinforcement learning system, a change requirement of a system in which an enormous number of patterns or combinations of parameters of the change procedure is considered, the configuration management device 100 of the present exemplary embodiment preferentially selects a combination of parameters that is valid in probability. That is, the configuration management device 100 can complete the learning within a realistic time by efficiently learning valid control operation.

In a method of evaluating and learning by repeatedly performing a trial of the operation of the IT system represented by reinforcement learning, the configuration management device 100 of the present exemplary embodiment can complete the evaluation and the learning within a realistic time even in a case where the number of the operation patterns becomes enormous to a degree of making it difficult to complete the operation within a realistic time. Further, the configuration management device 100 can generate an appropriate change procedure on the basis of a learning result.

### Description of Operation

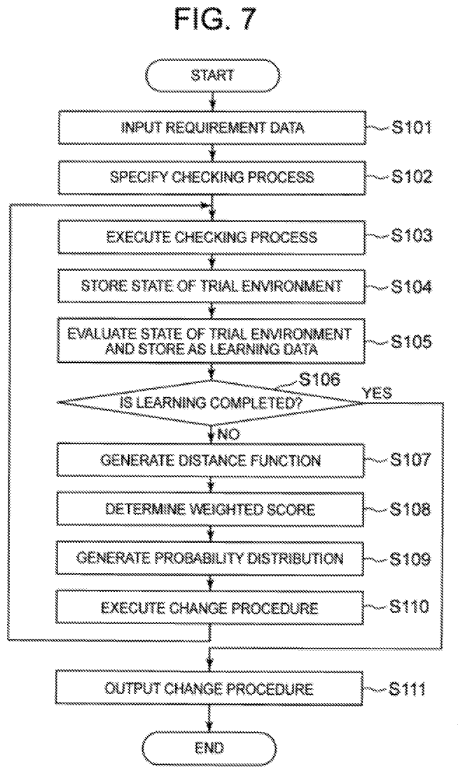

Hereinafter, an operation of generating a change procedure by the configuration management device 100 according to the present exemplary embodiment will be described with reference to FIG. 7. FIG. 7 is a flowchart showing an operation of a change procedure generation process by the configuration management device 100 of the first exemplary embodiment.

A user inputs requirement data defining a change requirement of a target system, to the learning management unit 120. That is, the learning management unit 120 acquires the requirement data (step S101).

Next, the learning management unit 120 inputs the requirement data to the state grasping unit 140. The state grasping unit 140 specifies a checking process for checking a state of the trial environment 200 on the basis of the inputted requirement data (step S102). Next, the state grasping unit 140 inputs the specified checking process to the learning management unit 120.

The learning management unit 120 executes the inputted checking process (step S103). Next, the learning management unit 120 stores a state of the current trial environment 200 checked by executing the checking process (step S104).

Next, the learning management unit 120 evaluates the state of the current trial environment 200, and stores the evaluation result as learning data in the learning data storage unit 160 (step S105). On the basis of the evaluation result and the like, the learning management unit 120 determines whether or not learning of the change procedure has been completed (step S106).

When it is determined that the learning has been completed (Yes in step S106), the procedure derivation unit 150 refers to the learning data storage unit 160 and extracts a change procedure that satisfies the change requirement. Next, the procedure derivation unit 150 outputs the extracted change procedure (step S111). After outputting the change procedure, the configuration management device 100 ends the change procedure generation process.

When it is determined that the learning has not been completed (No in step S106), the learning management unit 120 instructs the trial determination unit 130 to determine a change procedure of the trial content. The trial determination unit 130 that has received the instruction instructs the probability distribution determination unit 110 to generate a probability distribution.

The distance computation unit 111 of the probability distribution determination unit 110 that has received the instruction generates a distance function on the basis of inputted type of parameter information (step S107). Next, the distance computation unit 111 inputs the generated distance function to the weight assignment unit 112.

The weight assignment unit 112 inputted with the distance function generates a weighted score by using inputted past trial result information and weighting function (step S108). Next, the weight assignment unit 112 inputs the generated score to the distribution unit 113.

The distribution unit 113 inputted with the score generates a probability distribution on the basis of the score (step S109). Next, the distribution unit 113 inputs the generated probability distribution to the trial determination unit 130.

The trial determination unit 130 inputted with the probability distribution determines a change procedure of a next trial content on the basis of the probability distribution. Next, the trial determination unit 130 inputs the determined change procedure to the learning management unit 120.

The learning management unit 120 inputted with the change procedure executes the change procedure in the trial environment 200 (step S110). Next, the learning management unit 120 performs the processing of step S103 again. The processing of steps S101 to S110 corresponds to a learning process of the change procedure.

### Description of Effect

The configuration management device 100 according to the present exemplary embodiment can quickly execute reinforcement learning in which a qualitative parameter in a vast space is included in an action space when learning and generating a change procedure of an IT system.

Specifically, a time required for learning is reduced by efficiently selecting a pattern effective for learning from an enormous number of patterns that are trial candidates, by the trial determination unit 130 of the configuration management device 100. The probability distribution determination unit 110 generates a probability distribution for parameter selection such that an effective pattern is efficiently selected.

By defining a degree of similarity on the basis of an inclusion relation between parameters for qualitative parameters whose order and degree of similarity are not obvious, the probability distribution determination unit 110 generates a probability distribution such that a combination of parameters similar to an effective parameter is more easily selected. By selecting a trial target parameter in accordance with the generated probability distribution, the configuration management device 100 can efficiently perform a trial and learn the parameter estimated to be effective.

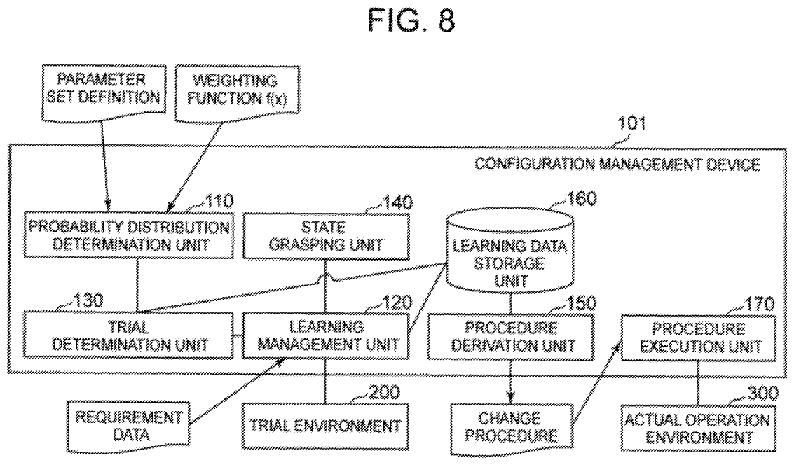

Note that the configuration management device may automatically apply data indicating a generated change procedure to an actual operation environment. FIG. 8 is a block diagram showing another configuration example of the first exemplary embodiment of the configuration management device according to the present invention.

As shown in FIG. 8, a configuration management device 101 of the present exemplary embodiment includes: a probability distribution determination unit 110, a learning management unit 120, a trial determination unit 130, a state grasping unit 140, a procedure derivation unit 150, a learning data storage unit 160, and a procedure execution unit 170.

Unlike the configuration management device 100 shown in FIG. 1, the procedure execution unit 170 is added to the configuration management device 101 shown in FIG. 8. A configuration of the configuration management device 101 shown in FIG. 8 other than the procedure execution unit 170 is similar to the configuration of the configuration management device 100 shown in FIG. 1.

The procedure execution unit 170 applies a change procedure generated by the procedure derivation unit 150 to an actual operation environment 300 in which a target system is operating. The procedure execution unit 170 executes, with the change procedure as an input, a change task in the actual operation environment 300.

The configuration management device 101 of the present exemplary embodiment can automatically apply the generated change procedure to the actual operation environment without requiring user operation.

Note that the configuration management devices 100 and 101 of the present exemplary embodiment may be realized, for example, by a CPU that executes processing in accordance with a program stored in a non-transitory storage medium. That is, the probability distribution determination unit 110, the learning management unit 120, the trial determination unit 130, the state grasping unit 140, the procedure derivation unit 150, and the procedure execution unit 170 may be realized, for example, by the CPU that executes processing in accordance with program control.

Further, the learning data storage unit 160 may be realized by, for example, a random access memory (RAM).

Further, each unit in the configuration management devices 100 and 101 of the present exemplary embodiment may be realized by a hardware circuit. As an example, the probability distribution determination unit 110, the learning management unit 120, the trial determination unit 130, the state grasping unit 140, the procedure derivation unit 150, the learning data storage unit 160, and the procedure execution unit 170 each are realized by large scale integration (LSI). In addition, they may be realized by one LSI.

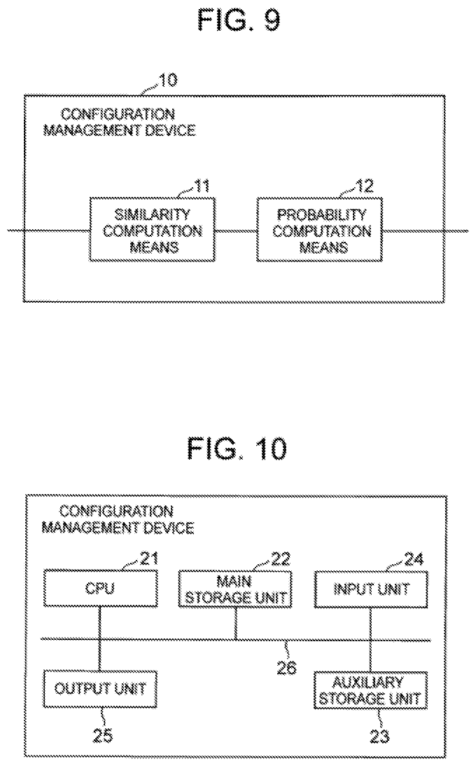

Next, another exemplary embodiment of the present invention will be described. FIG. 9 is a block diagram showing an outline of a configuration management device according to another exemplary embodiment of the present invention. A configuration management device 10 according to the present exemplary embodiment is a configuration management device that learns a change procedure by executing a trial change procedure among configuration change procedures for a system to be managed. The configuration management device 10 includes: similarity computation means 11 (for example, the distance computation unit 111) that computes, in accordance with a type of parameter, a degree of similarity between a candidate parameter to be included in the trial change procedure and a parameter which is included in an already-executed change procedure; and probability computation means 12 (for example, the distribution unit 113) that computes a probability that the candidate parameter is included in the trial change procedure by employing the computed degree of similarity.

Such a configuration allows the configuration management device to reduce the trial number when learning a change procedure of an IT system.

Further, the configuration management device 10 may include: selection means (for example, the learning management unit 120) that selects a parameter included in a next trial change procedure on the basis of a computed probability; and storage means (for example, the learning data storage unit 160) that stores an execution result of a trial change procedure including a selected parameter.

Such a configuration allows the configuration management device to adopt a candidate parameter selected with a high probability in a next trial change procedure.

Further, the configuration management device 10 may include giving means (for example, the weight assignment unit 112) that gives a score to the candidate parameter by employing an execution result stored in the storage means and a computed degree of similarity, and the probability computation means 12 may compute a probability that the candidate parameter is included in a trial change procedure by using a given score.

Such a configuration allows the configuration management device to generate a probability distribution on the basis of an execution result of a past change procedure.

Further, the configuration management device 10 may include deriving means (for example, the procedure derivation unit 150) that derives a change procedure to be used for configuration change of the system to be managed on the basis of an execution result stored in the storage means.

Such a configuration allows the configuration management device to derive a change procedure on the basis of a learning result.

Further, the configuration management device 10 may include execution means (for example, the procedure execution unit 170) that executes a derived change procedure in an environment in which the system to be managed is operating.

Such a configuration allows the configuration management device to automatically execute the derived change procedure.

Further, the similarity computation means 11 may compute a degree of similarity by using an inclusion relation of values of a plurality of parameters defined for each type of parameter.

Such a configuration allows the configuration management device to more easily compute a degree of similarity between qualitative parameters that is difficult to quantify.

In addition, the configuration management device 10 may be inputted with requirement data including a requirement of the system to be managed for which the user requests satisfaction, and a control operation that may be required to satisfy the requirement.

A description will be given to a specific example in a case where the present invention described in each exemplary embodiment described above is realized by using a processor such as a CPU as described above. FIG. 10 is an explanatory diagram showing an example of a hardware configuration that can execute the configuration management device according to each exemplary embodiment of the present invention.

The configuration management device shown in FIG. 10 includes a CPU 21, a main storage unit 22, and an auxiliary storage unit 23. Further, there may be provided an input unit 24 for a user to operate, and an output unit 25 for presentation of a processing result or a progress of a processing content to the user.

Note that the configuration management device shown in FIG. 10 may include a digital signal processor (DSP) instead of the CPU 21. Alternatively, the configuration management device shown in FIG. 10 may include both the CPU 21 and the DSP.

The main storage unit 22 is used as a work area for data and a temporary save area for data. The main storage unit 22 is, for example, a RAM.

The auxiliary storage unit 23 is a non-temporary tangible storage medium. Examples of the non-transitory tangible storage medium include, for example, a magnetic disk, a magneto-optical disk, a compact disk read only memory (CD-ROM), a digital versatile disk read only memory (DVD-ROM), and a semiconductor memory.

The input unit 24 has a function of inputting data and processing instructions. The input unit 24 is, for example, an input device such as a keyboard and a mouse.

The output unit 25 has a function of outputting data. The output unit 25 is, for example, a display device such as a liquid crystal display device or a printing device such as a printer.

Further, as shown in FIG. 10, in the configuration management device, each component is connected to a system bus 26.

The auxiliary storage unit 23 stores a program for realizing, for example, the probability distribution determination unit 110, the learning management unit 120, the trial determination unit 130, the state grasping unit 140, the procedure derivation unit 150, and the procedure execution unit 170.

Further, the configuration management device may be realized by software, by causing the CPU 21 shown in FIG. 10 to execute a program that provides a function of each component.

When realized by software, each function is realized by software by causing the CPU 21 to load a program stored in the auxiliary storage unit 23 into the main storage unit 22, execute the program, and control an operation of the configuration management device.

In addition, part or all of each component may be realized by general purpose circuitry or dedicated circuitry, a processor, or the like, or a combination thereof. These may be configured by a single chip or may be configured by a plurality of chips connected via a bus. Part or all of each component may be realized by a combination of the above-described circuitry and the like and a program.

When part or all of each component is realized by a plurality of information processing devices, circuits, and the like, the plurality of information processing devices, circuits, and the like may be arranged concentratedly or distributedly. For example, the information processing devices, the circuits, and the like may be realized as a form in which each is connected via a communication network, such as a client and server system, a cloud computing system, and the like.

Although the present invention has been described with reference to the exemplary embodiments and examples, the present invention is not limited to the above exemplary embodiments and examples. Various changes that can be understood by those skilled in the art can be made to the configuration and details of the present invention within the scope of the present invention.

This application claims priority based on Japanese Patent Application 2017-197022, filed on Oct. 10, 2017, the entire disclosure of which is incorporated herein.

### INDUSTRIAL APPLICABILITY

The present invention is suitably applied to a system configuration management tool or a system change management tool for automatically designing a process for a change operation required when an IT system specification is changed or responding to a failure, and for verifying and executing the designed process.

### REFERENCE SIGNS LIST

10, 100, 101 Configuration management device
11 Similarity computation means
12 Probability computation means
21 CPU
22 Main storage unit
23 Auxiliary storage unit
24 Input unit
25 Output unit
26 System bus
110 Probability distribution determination unit
111 Distance computation unit
112 Weight assignment unit
113 Distribution unit
120 Learning management unit
130 Trial determination unit
140 State grasping unit
150 Procedure derivation unit
160 Learning data storage unit
170 Procedure execution unit
200 Trial environment
300 Actual operation environment

What is claimed is:

1. A configuration management device that learns a change procedure by executing a trial change procedure among configuration change procedures for a system to be managed, the configuration management device comprising:
a similarity computation unit, implemented by a hardware including one or more processors, which computes, in accordance with a type of parameter, a degree of similarity between a candidate parameter to be included in the trial change procedure and a parameter which is included in an already-executed change procedure; and
a probability computation unit, implemented by the hardware, which computes a probability that the candidate parameter is included in the trial change procedure by employing the computed degree of similarity.

2. The configuration management device according to claim 1, further comprising:
a selection unit, implemented by the hardware, which selects a parameter included in a next trial change procedure on the basis of a computed probability; and
a storage unit, implemented by the hardware, which stores an execution result of a trial change procedure including a selected parameter.

3. The configuration management device according to claim 2, further comprising:
a giving unit, implemented by the hardware, which gives a score to the candidate parameter by employing an execution result stored in the storage unit and a computed degree of similarity, wherein
the probability computation unit computes a probability that the candidate parameter is included in a trial change procedure by using a given score.

4. The configuration management device according to claim 2, further comprising:
a deriving unit, implemented by the hardware, which derives a change procedure to be used for configuration change of the system to be managed on the basis of an execution result stored in the storage unit.

5. The configuration management device according to claim 4, further comprising:
an execution unit, implemented by the hardware, which executes a derived change procedure in an environment in which the system to be managed is operating.

6. The configuration management device according to claim 1, wherein
the similarity computation unit computes a degree of similarity by using an inclusion relation of values of a plurality of parameters defined for each type of parameter.

7. A computer-implemented configuration management method executed in a configuration management device that learns a change procedure by executing a trial change procedure among configuration change procedures for a system to be managed, the configuration management method comprising:
computing, in accordance with a type of parameter, a degree of similarity between a candidate parameter to be included in the trial change procedure and a parameter which is included in an already-executed change procedure; and
computing a probability that the candidate parameter is included in the trial change procedure by employing the computed degree of similarity.

8. The computer-implemented configuration management method according to claim 7, further comprising:
selecting a parameter included in a next trial change procedure on the basis of a computed probability; and
storing an execution result of a trial change procedure including a selected parameter.

9. A recording medium that is computer readable and has recorded a configuration management program executed in a computer that learns a change procedure by executing a trial change procedure among configuration change procedures for a system to be managed, the configuration management program performs,
when executed in the computer,
computation, in accordance with a type of parameter, a degree of similarity between a candidate parameter to be included in the trial change procedure and a parameter which is included in an already-executed change procedure; and
computation of a probability that the candidate parameter is included in the trial change procedure by employing the computed degree of similarity.

10. The recording medium according to claim 9, wherein
when executed on a computer,
selection a parameter included in a next trial change procedure on the basis of a computed probability; and
storing an execution result of a trial change procedure including a selected parameter.

11. The configuration management device according to claim 3, further comprising:
a deriving unit, implemented by the hardware, which derives a change procedure to be used for configuration change of the system to be managed on the basis of an execution result stored in the storage unit.

12. The configuration management device according to claim 11, further comprising:
an execution unit, implemented by the hardware, which executes a derived change procedure in an environment in which the system to be managed is operating.

13. The configuration management device according to claim 2, wherein
the similarity computation unit computes a degree of similarity by using an inclusion relation of values of a plurality of parameters defined for each type of parameter.

14. The configuration management device according to claim 3, wherein
the similarity computation unit computes a degree of similarity by using an inclusion relation of values of a plurality of parameters defined for each type of parameter.

15. The configuration management device according to claim 4, wherein
the similarity computation unit computes a degree of similarity by using an inclusion relation of values of a plurality of parameters defined for each type of parameter.

16. The configuration management device according to claim 5, wherein
the similarity computation unit computes a degree of similarity by using an inclusion relation of values of a plurality of parameters defined for each type of parameter.

17. The configuration management device according to claim 11, wherein
the similarity computation unit computes a degree of similarity by using an inclusion relation of values of a plurality of parameters defined for each type of parameter.

18. The configuration management device according to claim 12, wherein
the similarity computation unit computes a degree of similarity by using an inclusion relation of values of a plurality of parameters defined for each type of parameter.
